(19) United States
(12) Patent Application Publication
(10) Pub. No.: US 2025/0062585 A1
(43) Pub. Date: Feb. 20, 2025

(54) SPECIALIZED OPTICAL FIBER CLADDING FOR SUPPRESSING MODE COUPLING DURING TAPERING

(71) Applicant: OFS Fitel, LLC, Norcross, GA (US)

(72) Inventors: Dan Peter Jakobsen, Morkov (DK); Johannes Vorgod Jorgensen, Allerod (DK); Soren Herstrom, Ballerup (DK); Poul Kristensen, Valby (DK); Simona Ovtar, Brondby (DK); Casper J Schiott, Greve (DK)

(73) Assignee: OFS Fitel, LLC, Norcross, GA (US)

(21) Appl. No.: 18/720,196

(22) PCT Filed: Dec. 9, 2022
(86) PCT No.: PCT/US22/52459

§ 371 Date: Jun. 14, 2024

Related U.S. Application Data
(60) Provisional application No. 63/289,309, filed on Dec. 14, 2021.

(51) Int. Cl. H01S 3/067

(52) U.S. Cl. CPC H01S 3/06716; H01S 3/06729

(57) ABSTRACT

An optical fiber is formed to include a specialized cladding layer that exhibits a change in refractive index as the fiber is tapered, related to the out-diffusion of a refractive index-decreasing dopant included in the cladding layer. The change in refractive index (propagation constant) is sufficient to maintain the local taper angle relation and prevent the institution of loss oscillations as the length of the taper extends to a desired value. In particular, the specialized cladding layer may be formed to include a sufficient concentration of an index-decreasing dopant such as F, which is known to diffuse faster that the conventional cladding layer index-increasing dopants (e.g., one or more of Ge, Cl, and P).

### CROSS-REFERENCE TO RELATED APPLICATIONS

This application claims the benefit of U.S. Provisional Application No. 63/289,309, filed Dec. 14, 2021 and herein incorporated by reference.

### TECHNICAL FIELD

Disclosed herein is the subject matter of optical fiber tapers, such as used in fused optical couplers and wavelength division multiplexers (WDMs), or other applications where it is desired to maintain extremely low (approaching zero) nonadiabatic loss in an optical fiber taper.

### BACKGROUND OF THE INVENTION

Tapered optical fibers are used in many applications, with common examples being fused fiber couplers and WDMs where two or more fibers are fused together and thereafter tapered to create an adiabatic transition from one core region to the other. It is well known that not all fibers can be tapered without causing loss (attenuation) in the optical signals propagating through the tapered region. This type of loss may be quantified by the “adiabatic criteria”, which states that the maximum allowed local taper angle Ω(z) must adhere to the following relation:

$$Ω ( z ) < \frac{ρ ( z )}{2 π} ( {β}_{1} - {β}_{2} ) ,$$

where ρ(z) is the core radius, β₁ is the local propagation constant for the HE₁₁ mode, and β₂ is the local propagation constant for the HE₁₂ mode. It is obvious from the above that if the difference between β₁ and β₂ becomes too small, the HE₁₁ and HE₁₂ modes will experience a degree of coupling and loss oscillations will appear during tapering, which is undesirable for most applications. At times hereafter, reference may also be made to the refractive index values of a fiber's core and cladding, where the relationship between propagation constant β and refractive index n_{eff} is defined as follows:

$$β = {n}_{eff} ( \frac{2 π}{λ} ) ,$$

where λ is the wavelength of the lightwave propagating along the optical fiber core.

Conventional solutions to suppressing mode coupling have been based upon designing the refractive index profile of the optical fiber in such a way that the quantity (β₁-β₂) does not become too small. In particular, one common optical fiber configuration may add a small pedestal around the core, where the pedestal exhibits a refractive index between that of the core and the cladding. However, the inclusion of a pedestal is known to change the mode field diameter of the optical fiber, as well as its cutoff wavelength (the cutoff wavelength being the lowest wavelength where the fiber is able to support the propagation of a single mode optical signal). As a result, a compromise must be found that sufficiently suppresses the loss oscillations without impacting a reasonable cutoff wavelength. For example, when using a fused fiber coupler or WDM within an erbium-doped fiber amplifier (EDFA), the HE₁₂ cutoff needs to be below 980 nm, the pump wavelength used to create amplification. The restrictions associated with a given compromise may be very difficult to embody, particularly if there is a desire to match the refractive index profile of a fused fiber coupler with that of an EDFA itself.

### SUMMARY OF THE INVENTION

The needs remaining in the art are addressed by the present invention, which relates to optical fiber tapers, such as used in fused optical couplers and wavelength division multiplexers (WDMs), or other applications where it is desired to maintain extremely low (approaching zero) nonadiabatic loss in the taper. This type of loss is also referred to at times as “mode coupling loss” or “oscillating loss”.

In accordance with the principles of the present invention, it has been found that a cladding layer formed to include a refractive index-decreasing dopant (in combination with the conventional index-increasing cladding dopants) provides a change in refractive index as the fiber is tapered, the change being sufficient to maintain the local taper angle relation (adiabatic criteria) and prevent the institution of loss oscillations as the length of the taper extends to a desired value. In particular, this specialized cladding layer is formed to include a sufficient concentration of a refractive index-decreasing dopant (such as F), which is known to diffuse faster that the included index-increasing dopants (e.g., one or more of Ge, Cl, and P). The elevated temperature associated with the formation of a taper is sufficient to trigger the out-diffusion of the F, which thus modifies the refractive index profile of the specialized cladding layer as the diffusion continues.

It has been found that during the process of tapering an optical fiber including the specialized cladding layer, the fluorine (or other index-decreasing dopant, also referred to at times as a “down-dopant”) that is present in the cladding diffuses outward (away from the cladding) toward the outer boundary of the cladding layer (as well as diffusing slighting into the core region). The more the fiber is tapered, the larger the concentration of the diffused fluorine in the outer region of the cladding layer, increasing the average refractive index of the cladding area around the core initially doped with both up- and down-dopant material. Indeed, the overall effect is that a pedestal region “grows” in the region of the cladding layer immediately surrounding the core region as the tapering length is increased. The dopant concentrations (both the up-dopants and down-dopants), as well as the taper shape, may be controlled so as to maintain a difference between β₁ and β₂ that is sufficient to minimize coupling between the fundamental HE₁₁ mode and various other modes (including at least the HE₁₂ mode).

An exemplary embodiment of the present invention may take the form of an optical fiber having a specialized cladding layer formed to surround the central core region (the core region having a refractive index value of n_{core}). The specialized cladding layer is doped with both a refractive index-decreasing dopant and at least one refractive index-increasing dopant in a composition such that the surrounding cladding layer maintains a second refractive index n_{clad} less than n_{core}. The refractive index-decreasing dopant exhibits a higher diffusion rate than the at least one refractive index-increasing dopant sufficient to form a region of raised refractive index n_{ped} surrounding the core region during the formation of an optical fiber taper, where n_{core}>n_{ped}>n_{clad}. The creation of this pedestal region along the taper maintains separation between the HE₁₁ and HE₁₂ propagating modes and thus minimizes loss oscillations in the taper.

Other and further aspects and embodiments of the present invention will become apparent during the course of the following discussion and by reference to the accompanying drawings.

### BRIEF DESCRIPTION OF THE DRAWINGS

Referring now to the drawings, where like reference numerals represent like parts in several view:

FIG. 1 includes simulations of nonadiabatic loss as a function of taper length for different prior art fibers, FIG. 1(a) associated with a bend-insensitive fiber and FIG. 1(b) associated with a low cutoff wavelength fiber;

FIG. 2 is a cut-away end view of an exemplary optical fiber formed to include a specialized cladding layer in accordance with the teachings of the present invention;

FIG. 3 is a longitudinal view of a tapered region along the optical fiber of FIG. 2, taken along line 3-3 of FIG. 2, including an illustration of associated refractive index profiles at specific locations along the taper;

FIG. 4 is a comparison of a prior art optical fiber (PLOT A) with an optical fiber including a specialty cladding formed in accordance with the present invention (PLOT B), plotting the difference between the effective refractive indices of the HE₁₁ and HE₁₂ modes as a function of fiber diameter reduction ratio;

FIG. 5 illustrates loss measurements as a function of taper length, the plot of FIG. 5(a) associated with the prior art-related data in PLOT A of FIG. 4 and the plot of FIG. 5(b) associated with invention-related data in PLOT B of FIG. 4; and

FIG. 6 is a simulation plotting taper loss as a function of taper elongation for both a prior art fiber and a fiber with a specialty cladding formed in accordance with the teachings of the present invention.

### DETAILED DESCRIPTION

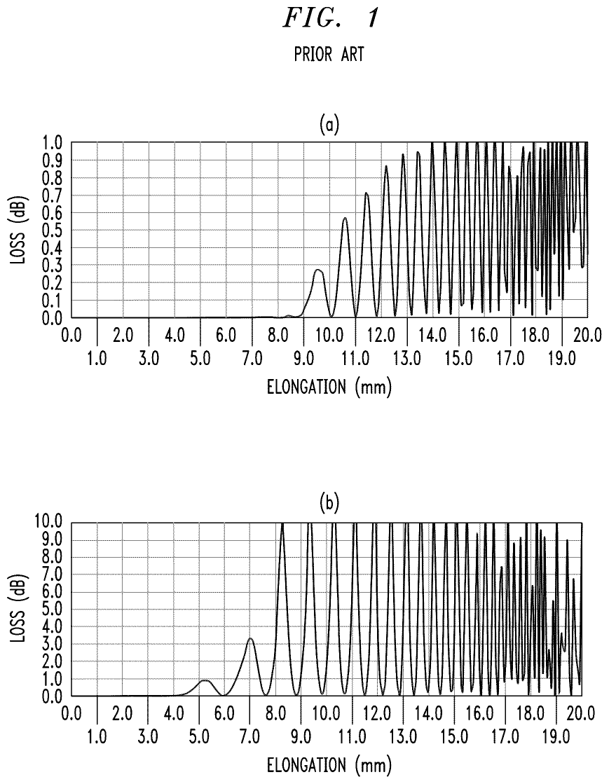

It is well known that some optical fiber tapers show rapid oscillations in their output power spectrum during the taper pulling process, where the amplitudes of these oscillations are known to be a function of the type of optical fiber and the taper geometry. FIG. 1 contains a set of simulations (verified) showing the increase in oscillations as a function of increase in taper length for two types of prior art optical fibers. The plot in FIG. 1(a) is associated with a bend-insensitive specialty fiber and the plot in FIG. 1(b) is associated with a low cutoff wavelength specialty fiber. The plot in FIG. 1(a) indicates that oscillations begin to impact the fiber's ability to maintain mode decoupling when the taper reaches a length of about 9 mm. Referring to the plot of FIG. 1(b), it is shown that a low cutoff wavelength fiber begins to experience the presence of oscillations (i.e., nonadiabatic loss) as the taper reaches a length of about only 5 mm. These oscillations are attributed to the unwanted interactions between the HE₁₁ mode and the HE₁₂ mode (as well as perhaps some other higher-order modes propagating within the cladding).

Clearly, the presence of these oscillations in the output power is undesirable in applications such as, but not limited to, low-loss tapers and couplers/WDMs, resulting in the need to intentionally design the optical fibers in such a way that the loss mechanisms are suppressed as much as possible. Complicating the situation is the fact that the process used for tapering the fiber is also important and cannot introduce power transfer from the fundamental HE₁₁ core mode to the cladding modes (such as HE₁₂), as this will also trigger the onset of loss oscillations.

In other words, the tapering process needs to be adiabatic (preserving the propagating mode during tapering) and abide by the limitation for the local taper angle Ω(z) defined above. The following discussion outlines the inventive process of using dopant diffusion to ensure that the tapering process minimizes loss oscillations. As discussed in detail below, it has been found that diffusion of selected dopants within the cladding may be used to control the values of β₁ and β₂ during the tapering process, where the out-diffusion of down-dopants (e.g., fluorine) within the cladding during tapering effectively “grows up” a pedestal structure between the core and the cladding as the tapering process progresses. That is, the out-diffusion of the down-dopants during tapering has been found to ensure that the difference between β₁ and β₂ does not become too small (impacting the adiabatic criteria discussed above) as the tapering process continues.

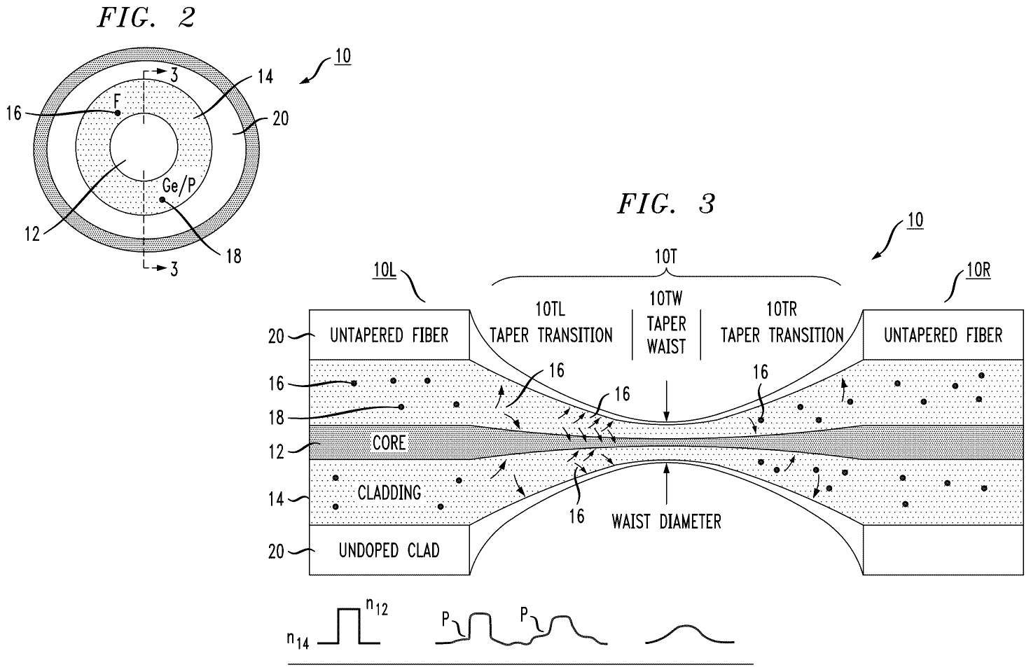

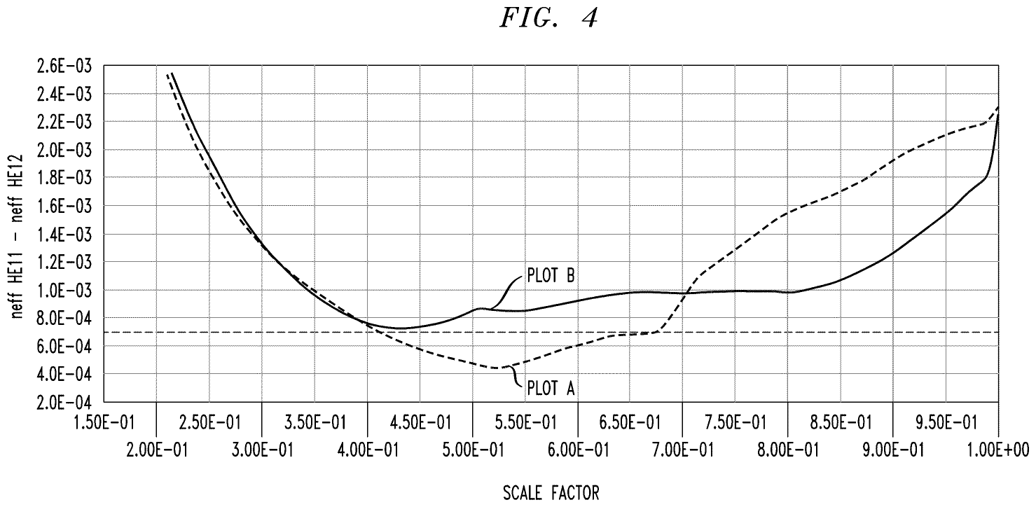

FIG. 2 is a cut-away end view of an exemplary optical fiber 10 formed to include a specialized cladding layer in accordance with the teachings of the present invention, with FIG. 3 being a longitudinal view of an interior tapered region of optical fiber 10, taken along line 3-3 of FIG. 2. FIG. 3 also includes sketches of exemplary refractive index profiles associated with selected locations along the taper.

Referring back to FIG. 2, optical fiber 10 is shown as comprising a central core region 12 surrounded by a specialized cladding layer 14 formed in accordance with the principles of the present invention. Specialized cladding layer 14 typically comprises a silica material and is fabricated to include both a refractive index-decreasing (down) dopant 16 (such as fluorine) and one or more refractive index-increasing (up) dopant 18 (such as chlorine, germanium, and/or phosphorous). It is an important aspect of the present invention that down-dopant 16 exhibits a higher diffusion rate than any of the up-dopants 18, since the necessary movement of down-dopant 16 is triggered by the elevated temperature conditions associated with the formation of an optical fiber taper. That is, the temperatures associated with the formation of an optical fiber taper are recognized as sufficient to cause the out-diffusion of down-dopant 16, while up-dopant 18 remains relatively in place during the process. The particular illustration of FIG. 2 also shows an undoped outer cladding layer 20 surrounding specialized cladding layer 14.

FIG. 3 illustrates the out-diffusion of down-dopant 16 during an exemplary tapering process and its influence on changing the refractive index profile of the resultant fiber structure. The most left-hand and right-hand portions of the longitudinal view of optical fiber 10 in FIG. 3, shown as fiber sections 10L and 10R, depict a structure without any taper. Here, down-dopants 16 and up-dopants 18 are present in their as-fabricated positions within specialized cladding layer 14. Optical fiber 10 is shown as exhibiting a typical step-index refractive index profile for sections 10L and 10R, where the refractive index of core region 12 (n₁₂) is relatively greater than the refractive index of specialty cladding layer 14 (n₁₄), maintaining propagation of the fundamental HE₁₁ mode essentially within core region 12. An interior section 10T of optical fiber 10 illustrates where the tapering process is performed.

At the beginning of the tapering process, down-dopant 16 starts to diffuse out of cladding layer 14 toward both core region 12 and outer cladding 20, as depicted in taper transition sections 10TL and 10TR of FIG. 3. The refractive index profile of fiber 10 begins to change along transition sections 10TL and 10TR, the profile illustrated in the vicinity of transition section 10TL for the sake of illustration. As shown, the initial out-diffusion of down-dopant 16 begins the formation of a pedestal P surrounding core region 12. The diffusion of down-dopant 16 into core region 12 also begins to “round” its profile, where both the pedestal formation and core profile rounding continuing as the tapering process continues.

The continuation of the tapering process ultimately results in forming a central taper waist 10TW between transition sections 10TL and 10TR. In accordance with the principles of the present invention, the continuation of the tapering process also provides for the continuing out-diffusion of down-dopant 16 away from specialized cladding layer 14. Referring to the refractive index profile associated with taper waist 10TW, the continuing out-diffusion of down-dopant 16 further increases the index value of pedestal P while somewhat lowering (and further rounding) the refractive index of core region 12. In this example, the refractive index profile has become essentially Gaussian in form due to diffusion. In accordance with the principles of the present invention, the out-diffusion of down-dopant 16 will inhibit, if not entirely prevent, the onset of mode coupling between the HE₁₁ and HE₁₂ modes. The suppression of mode coupling thus significantly reduces the amount of oscillation that may be generated along tapered section 10T, improving coupling efficiency from one fiber to another.

In the formation of optical fiber 10, specialized cladding layer 14 may exhibit a variety of different refractive index profiles prior to beginning a tapering process. The refractive index profile may be matched, unmatched, or even contain small trenches and barriers in its refractive index profile. The up-dopants and down-dopants are typically deposited simultaneously in the cladding material using well-understood depositions processes. The relative amounts of the up- and down-dopants determine the final refractive index profile of cladding layer 14. Moreover, it is contemplated that the relative dopant amounts do not need to maintain a constant value in the radial direction, allowing for a gradient in dopant concentration to be used as well to control the development of the oscillation-suppressing pedestal.

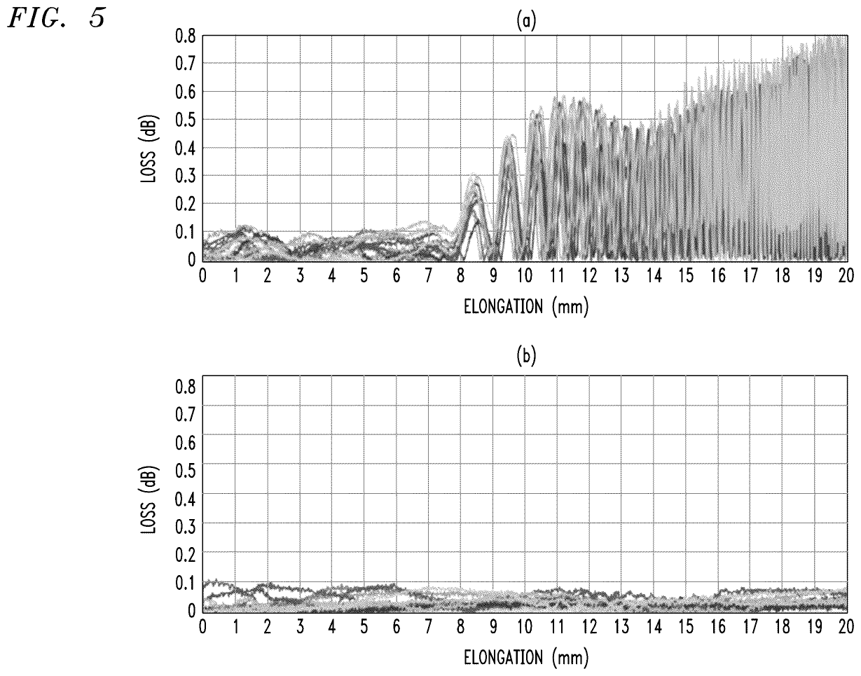

The reduction in the onset of oscillations in a fiber taper based on the specialized cladding layer of present invention is evident in the graph of FIG. 4, which plots the difference between the effective index for the HE₁₁ mode (n_{eff11}) and the HE₁₂ mode (n_{eff12}) as a function of fiber diameter reduction ratio (the “scale factor”). As mentioned above, the smaller the difference in propagation constants between the HE₁₁ mode and the HE₁₂ mode, the more likely that loss oscillations will be present in the fiber. The 0.05 dB threshold shown in FIG. 3 is a selected threshold for loss oscillations, where any data below this threshold can be defined as a situation where the oscillation loss is too high to be acceptable.

In particular, FIG. 4 includes plots for two fibers having identical refractive index profiles before any tapering commences and, therefore, exhibit essentially the same optical properties in terms of mode confinement, mode geometry, and the like. Plot A is associated with a conventional, prior art fiber that begins to exhibit oscillation relatively quickly as tapering progresses. In this particular example, the plot drops below the 0.05 dB threshold when the scale factor goes above about 0.4. In contrast, Plot B is associated with an optical fiber formed in accordance with the present invention, having a cladding layer comprising both up-dopants and down-dopants. The composition and concentration of these dopants is such that the inventive fiber exhibits the same characteristics as a conventional fiber in the absence of tapering (which is an important attribute when initially coupling fibers together). As shown in Plot B, by virtue of incorporating a relatively high diffusion rate down-dopant (in this case, F), the propagating HE₁₁ and HE₁₂ modes stay well separated, the difference between their respective propagation constants β₁ and β₂ maintained above the 0.05 dB threshold.

FIG. 5(a) is a plot of actual measurements of loss as a function of taper length for the prior art fiber associated with Plot A of FIG. 4, and FIG. 5(b) is a plot of actual measurements of loss for the inventive fiber associated with Plot B of FIG. 4. The presence of oscillations during the tapering of the prior art fiber is quite obvious, and begins to become noticeable once the taper reaches a length of about 8 mm or so. In contrast, the measurements shown in FIG. 5(b) clearly show that the loss stays below about 0.1 dB, even if the tapering extends to a length on the order of 20 mm or so.

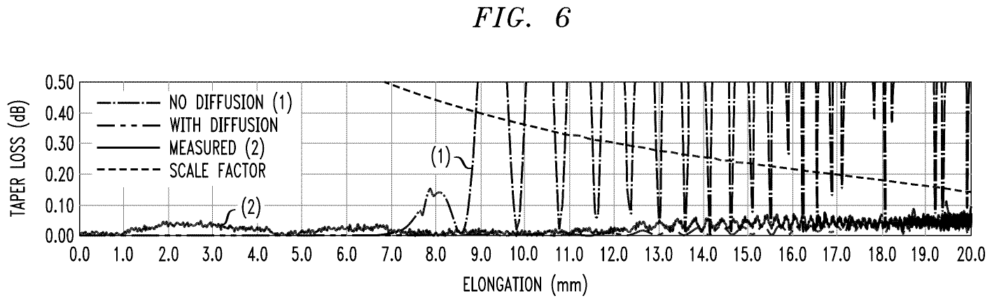

FIG. 6 is another graph (computer simulations) illustrating the reduction of mode coupling loss for the fiber of the present invention. The two curves shown here are again for comparisons between a prior art fiber and the inventive fiber, with both fibers again formed to exhibit the same refractive index profile prior to tapering. As shown, curve (1) is associated with the tapering of a prior art fiber and curve (2) associated with the tapering of the inventive fiber with the specialty cladding layer that comprises a select amount of high diffusion rate down-dopant (e.g., F). Again, as shown in plot (1), strong oscillations become present within the prior art fiber once the tapering extends beyond 8 mm. Plot (2) shows only negligible losses occurring along a tapered fiber having the specialty cladding layer of the present invention.

Summarizing, the data shown in the various plots confirms that the out-diffusion of down-dopants (at a higher rate than the up-dopants) as tapering progresses has a significant influence on the presence of loss oscillations. This out-diffusion increases the effective diameter of the fiber core ρ(z), which in turn reduces the loss oscillations in accordance with the adiabatic conditions for the local taper angle Ω(z). The out-diffusion of the dopant also changes the effective index difference between the HE₁₁ and HE₁₂ modes, as described above, and thus also contributes to maintaining Ω(z) well below the threshold.

The present invention has been described with reference to exemplary embodiments thereof. All exemplary embodiments and conditional illustrations described in this disclosure have been described with the intent to assist in the understanding of the principles and concepts of the present invention by those skilled in the art to which the present invention pertains. Therefore, it will be understood by those skilled in the art that the present invention may be implemented in modified forms without departing from the spirit and scope of this disclosure. Although numerous embodiments having various features have been described herein, combinations of such various features in other combinations not discussed herein are contemplated to be within the scope of the embodiments as defined by the claims appended hereto.

What is claimed is:

1. An optical fiber, comprising:
a core region having a first refractive index n_{core}; and
a specialized cladding layer disposed to surround the core region, the specialized cladding layer doped with both a refractive index-decreasing dopant and at least one refractive index-increasing dopant in a composition such that the surrounding cladding layer exhibits a second refractive index n_{clad} less than n_{core}, the refractive index-decreasing dopant exhibiting a higher diffusion rate than the at least one refractive index-increasing dopant sufficient to create a region of raised refractive index n_{ped} surrounding the core region during the formation of an optical fiber taper, where n_{core}>n_{ped}>n_{clad}.

2. The optical fiber as defined in claim 1 wherein the specialized cladding layer comprises silica, with the concentrations of the refractive index-decreasing dopant and the at least one refractive index-increasing dopant selected such that n_{clad} is essentially equal to the refractive index of undoped silica.

3. The optical fiber as defined in claim 1 wherein the refractive index-decreasing dopant included in the specialized cladding layer comprises fluorine (F).

4. The optical fiber as defined in claim 3 wherein the refractive index-increasing dopant consists of at least one component selected from the group consisting of: germanium (Ge), phosphorus (P), and chlorine (Cl).

5. The optical fiber as defined in claim 4 wherein the relative concentrations of the F and one or more of Ge, P, Cl are controlled to exhibit a defined refractive index n_{clad} within the specialized cladding layer in a non-tapered section of the optical fiber.

6. The optical fiber as defined in claim 5 wherein the defined refractive index within the specialized cladding layer maintains an essentially constant value as a function of optical fiber radius.

7. The optical fiber as defined in claim 5 wherein the defined refractive index within the specialized cladding layer changes as a function of optical fiber radius, forming a graded-index specialized cladding layer.

8. The optical fiber as defined in claim 5 wherein the defined refractive index within the specialized cladding layer is created to match a refractive index of a coupling optical element.

9. The optical fiber as defined in claim 1 wherein
β₁ is a local propagation constant associated with a propagating HE₁₁ mode, β₂ is a local propagation constant associated with a propagating HE₁₂ mode, and the core region is defined by an effective radius ρ(z), wherein the concentration of the refractive index-decreasing dopants and the refractive index-increasing dopants are selected to maintain the difference between β₁ and β₂ during tapering at a value that satisfies an adiabatic criteria related to a maximum allowed local taper angle Ω(z) as
$$Ω ( z ) < \frac{ρ ( z )}{2 π} ( {β}_{1} - {β}_{2} ) .$$

10. The optical fiber as defined in claim 9 wherein the refractive index of an interior portion of the specialized cladding layer immediately adjacent to the core region increases in value as a tapering process of the optical fiber progresses, yielding formation of a pedestal region surrounding the core region.

11. The optical fiber as defined in claim 1 wherein the core region includes a rare earth dopant, providing an optical fiber useful for operation of an optical fiber amplifier.
